(19) United States
(12) Patent Application Publication
(10) Pub. No.: US 2023/0236286 A1
(43) Pub. Date: Jul. 27, 2023

(54) RADIO WAVE REFLECTION REDUCING SHEET AND VEHICLE MEMBER

(71) Applicant: 3M INNOVATIVE PROPERTIES COMPANY, St. Paul, MN (US)

(72) Inventors: Masataka Shinagawa, Niiza-Shi (JP); Tomoaki Uchiya, Tokyo (JP); Koji Hishitani, Hachiouji (JP); Naoyuki Toriumi, Minami-ku, Sagamihara-city (JP); Masaaki Takeda, Sagamihara (JP)

(21) Appl. No.: 17/918,961

(22) PCT Filed: Mar. 16, 2021
(86) PCT No.: PCT/IB2021/052189

§ 371 Date: Oct. 14, 2022

Related U.S. Application Data
(60) Provisional application No. 63/011,580, filed on Apr. 17, 2020.

(51) Int. Cl. G01S 7/03; B32B 5/32; B32B 5/18; B32B 7/02; G01S 7/02; B62D 29/00

(52) U.S. Cl. CPC G01S 7/038; B32B 5/32; B32B 5/18; B32B 7/02; G01S 7/027; B62D 29/00; B32B 2255/102; B32B 2255/26; B32B 2307/7376; B32B 2307/72; B32B 2307/212; B32B 2605/00; B32B 2266/025; B32B 2266/0242

(57) ABSTRACT

A radio wave reflection reducing sheet provided with a laminate having a first primary surface and a second primary surface is disclosed. The laminate has: a first resin foam layer having a thickness from 0.05 to 3.00 mm and a density from 0.10 to 0.85 g/cm³, and a second resin foam layer having a thickness from 0.05 to 3.00 mm and a density from 0.20 to 0.90 g/cm³. The density of the second resin foam layer is greater than the density of the first resin foam layer. The first resin foam layer and the second resin foam layer are disposed in this order from the first primary surface side.

### TECHNICAL FIELD

The present disclosure relates to a radio wave reflection reducing sheet and a vehicle member.

### BACKGROUND ART

Efforts to equip automobiles with E-band frequency band radar devices are advancing in order to improve automotive safety and further advance towards practical applications of automated driving.

### SUMMARY

Radar devices mounted in automobiles need to detect not only four-wheeled vehicles and larger commercial vehicles in the surrounding area, but also pedestrians and compact vehicles such as two-wheeled vehicles. However, reflected waves from a human body and compact vehicles are weak, and therefore detection of these target objects to be detected by a radar device is easily affected by noise. In particular, when a radar device is provided inside a cover member, it tends to be difficult to detect a human body or such with high accuracy due to the impact of waves reflected by the cover member. Therefore, in order to detect weak reflected waves from a human body or the like with high accuracy using a radar device provided inside a cover member, it is desirable to suppress the reflected waves from the cover member as much as possible. An effective measure for achieving this is to enable an effective reduction of reflected waves, particularly in a desired region of an E-band frequency band from approximately 60 to 90 GHz.

One aspect of the present disclosure provides a radio wave reflection reducing sheet provided with a laminate having a first primary surface and a second primary surface. The laminate of the radio wave reflection reducing sheet includes a first resin foam layer having a thickness from 0.05 to 3.00 mm and a density from 0.10 to 0.85 g/cm³, and a second resin foam layer having a thickness from 0.05 to 3.00 mm, and a density from 0.20 to 0.90 g/cm³. The density of the second resin foam layer is greater than the density of the first resin foam layer. The first resin foam layer and the second resin foam layer are disposed in this order from the first primary surface side.

Another aspect of the present disclosure provides a vehicle member provided with a body portion and the radio wave reflection reducing sheet provided on an outer surface of the body portion; wherein the second primary surface of the laminate is adjacent to the body portion.

### BRIEF DESCRIPTION OF DRAWINGS

FIG. 1 is a cross-sectional view illustrating an embodiment of a radio wave reflection reducing sheet.

FIG. 2 is a cross-sectional view illustrating an embodiment of a radio wave reflection reducing sheet.

FIG. 3 is a cross-sectional view illustrating an embodiment of a radio wave reflection reducing sheet.

FIG. 4 is a cross-sectional view illustrating an embodiment of a radio wave reflection reducing sheet.

FIG. 5 is a cross-sectional view illustrating an embodiment of a radio wave reflection reducing sheet.

FIG. 6 is a cross-sectional view illustrating an embodiment of a radio wave reflection reducing sheet.

FIG. 7 is a cross-sectional view illustrating an embodiment of a vehicle member having a radio wave reflection reducing sheet, and a radar device.

FIG. 8 is a graph showing the correlation between relative permittivity at 76.5 GHz and relative permittivity at 1 GHz.

FIG. 9 is a graph showing an example of the relationship between the strength and frequency of reflected radio waves.

Several embodiments of the present disclosure will be described in detail below. However, the present disclosure is not limited to the following embodiments. Note that in the descriptions of the drawings, identical or equivalent components are assigned identical reference numerals and duplicate descriptions thereof are omitted.

### DETAILED DESCRIPTION

In the present specification, unless otherwise specified, the term “or” used herein shall generally include the meaning of “and/or”.

All numbers expressing amounts, components, measurements of properties, and the like used herein may be modified by the term “approximately” unless otherwise indicated. In view of the number of reported significant digits, each numeric parameter may be interpreted by applying ordinary rounding.

In the present specification, “(meth)acryloyl” means either “methacryloyl” or “acryloyl”. The same is true for other similar terms.

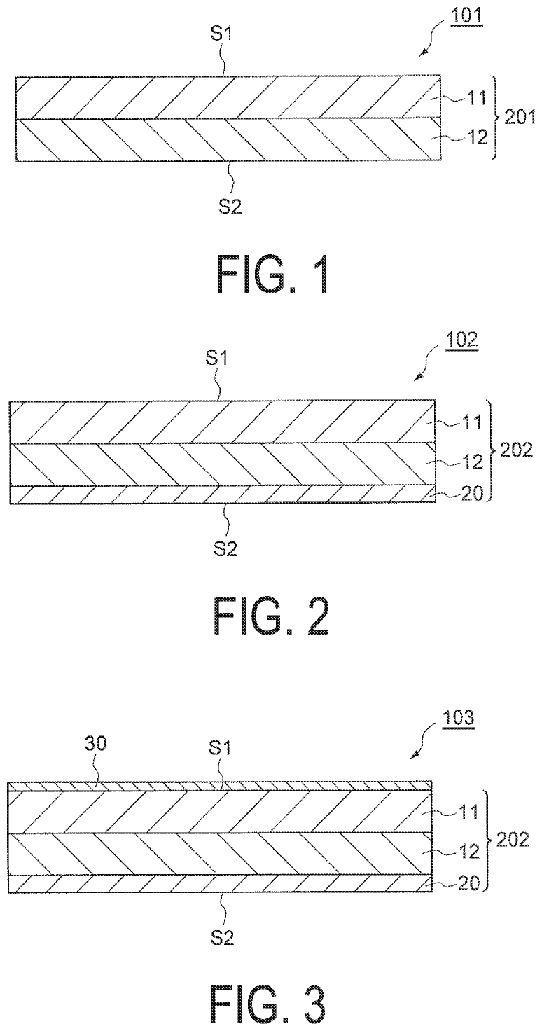

FIG. 1 is a cross-sectional view illustrating an embodiment of a radio wave reflection reducing sheet. A radio wave reflection reducing sheet 101 illustrated in FIG. 1 is configured from a laminate 201 having a first primary surface S1 and a second primary surface S2 on a back side thereof. The laminate 201 includes a first resin foam layer 11 and a second resin foam layer 12, and the first resin foam layer 11 and the second resin foam layer 12 are disposed in this order from the first primary surface S1 side.

“Resin foam layer” means a sheet containing a resin material and a plurality of gas bubbles dispersed in the resin material. The gas bubbles may be, for example, a gas expanded in the resin material, or a gas encased in hollow particles dispersed in the resin material. The gas bubble diameter (maximum width of the gas bubbles) is not particularly limited, but may be, for example, an average from 10 to 130 μm. The gas in the gas bubbles may be, for example, air or a low-boiling point compound such as a hydrocarbon derived from a foaming agent or the like. The resin foam layer typically has a density that is less than the density of the resin material alone. The resin materials that form the first resin foam layer 11 and the second resin foam layer 12 may be mutually the same or different.

The first resin foam layer 11 has a thickness from 0.05 to 3.00 mm and a density from 0.10 to 0.85 g/cm³. The second resin foam layer 12 has a thickness from 0.05 to 3.00 mm and a density from 0.20 to 0.90 g/cm³. The density of the second resin foam layer 12 is greater than the density of the first resin foam layer 11. The density becomes greater in order from the first resin foam layer 11 to the second resin foam layer 12, and thereby the reflection of radio waves at the interface between the second primary surface S2 and an adherend (for example, a body portion 60 described below) to which the radio wave reflection reducing sheet 101 is adhered is effectively reduced by the radio wave reflection reducing sheet 101. The radio wave reflection reducing sheet 101 is normally installed near a laser device, and is oriented such that the first primary surface S1 is located on the radar device side.

The thickness of the first resin foam layer 11 may be greater than or equal to 0.10 mm, greater than or equal to 0.20 mm, greater than or equal to 0.30 mm, or greater than or equal to 0.40 mm, and may be less than or equal to 2.00 mm, less than or equal to 1.00 mm, or less than or equal to 0.90 mm. The density of the first resin foam layer 11 may be greater than or equal to 0.20 g/cm³, or greater than or equal to 0.30 g/cm³, and may be less than or equal to 0.80 g/cm³, less than or equal to 0.75 g/cm³, or less than or equal to 0.50 g/cm³.

The thickness of the second resin foam layer 12 may be greater than or equal to 0.10 mm, greater than or equal to 0.20 mm, greater than or equal to 0.30 mm, or greater than or equal to 0.40 mm, and may be less than or equal to 2.00 mm, less than or equal to 1.00 mm, or less than or equal to 0.90 mm. The density of the second resin foam layer 12 may be greater than or equal to 0.30 g/cm³, greater than or equal to 0.40 g/cm³, or greater than or equal to 0.50 g/cm³, and may be less than or equal to 0.80 g/cm³.

The first resin foam layer 11 may have a relative permittivity from 1.1 to 4.0 at 76 to 77 GHz, and the second resin foam layer 12 may have a relative permittivity from 1.2 to 4.0 at 76 to 77 GHz. The relative permittivity of the second resin foam layer 12 may be greater than the relative permittivity of the first resin foam layer 11. The relative permittivity of the first resin foam layer 11 at 76 to 77 GHz may be greater than or equal to 1.2, and may be less than or equal to 3.0, less than or equal to 2.0, or less than or equal to 1.7. The relative permittivity of the second resin foam layer 12 at 76 to 77 GHz may be greater than or equal to 1.3, greater than or equal to 1.4, greater than or equal to 1.5, or greater than or equal to 1.6, and may be less than or equal to 3.0, or less than or equal to 2.0.

The resin material constituting the first resin foam layer 11 or the second resin foam layer 12 is not particularly limited, but may include, for example, a cured product of a curable resin composition, a thermoplastic resin, or both. The “curable resin composition” includes a monomer compound, and a polymer is produced by polymerization of the monomer compound, and thereby the curable resin composition is cured.

The curable resin composition for forming the first resin foam layer 11 or the second resin foam layer 12 may include a monomer compound having one or more (meth)acryloyl groups. The cured product of the monomer compound having a (meth)acryloyl group includes an acrylic resin formed by polymerization of the monomer compound. Examples of monomer compounds having a (meth)acryloyl group include alkyl (meth)acrylates, (meth)acrylic acids, and aryl (meth)acrylates. The number of carbon atoms in the alkyl group contained in the alkyl (meth)acrylate may be from 1 to 14. Specific examples of alkyl (meth)acrylates include methyl (meth)acrylate, ethyl (meth)acrylate, n-propyl (meth)acrylate, isopropyl (meth)acrylate, n-butyl (meth)acrylate, tert-butyl (meth)acrylate, isobutyl (meth)acrylate, n-pentyl (meth)acrylate, n-hexyl (meth)acrylate, cyclohexyl (meth)acrylate, n-heptyl (meth)acrylate, n-octyl (meth)acrylate, isobornyl (meth)acrylate, and 2-ethylhexyl (meth)acrylate. The content of the monomer compound having a (meth)acryloyl group may be from 80 to 100 mass % based on the mass of the curable resin composition. When the content of the monomer compound having a (meth)acryloyl group is 100 mass %, a resin foam layer is formed, for example, by mechanical foaming (foaming through an inflow of an inert gas such as nitrogen).

The curable resin composition containing a monomer compound having a (meth)acryloyl group may further include a photopolymerization initiator, a thermal polymerization initiator, or both. The photopolymerization initiator is a compound that is activated by active light rays such as ultraviolet light, and initiates polymerization of the monomer compound. The photopolymerization initiator may be a commercially available product, examples of which include DAROCURE 4265, IRGACURE 184, IRGACURE 651, IRGACURE 1173, IRGACURE 819, LUCIRIN TPO, and LUCIRIN TPO-L, which are available from BASF. The content amount of the photopolymerization initiator or the thermal polymerization initiator may be, for example, from 0.01 to 1 part by mass per 100 parts by mass of the monomer compound.

The thermoplastic resin for forming the first resin foam layer 11 or the second resin foam layer 12 may be, for example, a polyolefin such as polypropylene and polyethylene, a polycarbonate, AES, or ABS.

The resin composition for forming the first resin foam layer 11 or the second resin foam layer 12 may include a foaming agent for generating gas bubbles, hollow particles, or both. The foaming agent that generates gas bubbles may be a thermally expanding foaming agent. The thermally expanding foaming agent includes, for example, a shell containing a thermoplastic resin, and a liquid component encased in the shell. The thermally expanding foaming agent may be referred to as thermally expandable microspheres or thermally expandable microcapsules. The foaming agent that generates gas bubbles may be a chemical foaming agent. The hollow particles may be hollow glass particles or hollow resin particles, for example. When the content amount of the foaming agent that generates gas bubbles and the hollow particles is large, the percentage of gas bubbles in the first resin foam layer 11 or the second resin foam layer 12 increases, and as a result, the density of these resin foam layers is reduced. Accordingly, the density of each of the resin foam layers can be controlled based on the content amount of the foaming agent and the hollow particles.

The first resin foam layer 11 and the second resin foam layer 12 may further contain, as necessary, other components such as a dispersant.

The shape and surface area of the first and second primary surfaces S1, S2 can be optionally adjusted by the size of the region where reduced reflection is required.

The first resin foam layer 11 and the second resin foam layer 12 can be formed by a method that includes, for example, melt-kneading a resin composition containing a resin material, and a gas bubble-generating foaming agent or hollow particles or both, the melt-kneading being performed by a method such as extrusion molding, and sandwiching the kneaded product between two sheet-shaped liners to form a sheet. When the resin material is a curable resin composition, the sheet-shaped kneaded product may be cured by photoirradiation or heating. The sheet-shaped kneaded product may be further heated to facilitate the formation of gas bubbles by the foaming agent. The laminate 201 can be formed by laminating the obtained resin foam layer (resin foam sheet) with a method such as thermocompression bonding.

FIG. 2 is a cross-sectional view illustrating another embodiment of a radio wave reflection reducing sheet. A radio wave reflection reducing sheet 102 illustrated in FIG. 2 is configured from a laminate 202 further having a pressure sensitive adhesive layer 20 as the outermost layer of the second primary surface S2 side, the pressure sensitive adhesive layer 20 being provided adjacent to the second resin foam layer 12, and thereby the radio wave reflection reducing sheet 102 differs from the radio wave reflection reducing sheet 101 illustrated in FIG. 1.

The pressure-sensitive adhesive layer 20 is a layer having pressure sensitive adhesiveness (tackiness) for adhering to an adherend by applying a load. In other words, the pressure-sensitive adhesive layer 20 may satisfy the Dahlquist condition for exhibiting tackiness, that is, the condition that tensile compliance after 1 second of applying a load is greater than or equal to 10⁻⁷ cm²/dyne (or the tensile elastic modulus is less than or equal to 10⁷ dyne/cm²). The pressure-sensitive adhesive layer 20 allows the radio wave reflection reducing sheet 102 to be easily adhered to various adherends. When the pressure-sensitive adhesive layer 20 is not provided separately from the resin foam layer, the resin foam layer (for example, the second resin foam layer 12 in the case of FIG. 1) that constitutes the second primary surface S2 may have pressure sensitive adhesiveness. The pressure sensitive adhesive layer 20 can be formed using a material selected from those commonly used as pressure-sensitive adhesive materials. The thickness of the pressure sensitive adhesive layer 20 may be from 0.01 to 1.00 mm, for example. Instead of the pressure sensitive adhesive layer 20, a thermally curable or photocurable adhesive layer may be provided.

FIG. 3 is also a cross-sectional view illustrating another embodiment of the radio wave reflection reducing sheet. A radio wave reflection reducing sheet 103 illustrated in FIG. 3 has a protective film 30 formed on the first primary surface S1, and thereby differs from radio wave reflection reducing sheet 102 of FIG. 2. The protective film is mainly provided for the purpose of preventing contamination of the laminate 202, or for the purpose of reducing tackiness when the first resin foam layer 11 has tackiness. The protective film 30 is typically a film that is substantially free of gas bubbles. The material that forms the protective film 30 is not particularly limited, but may be a material that is tack-free at room temperature and exhibits a high level of adherence with the first resin foam layer 11. For example, the protective film 30 may be a film including a polymethylmethacrylate (PMMA) resin. The protective film 30 may be a film including a silicone-based or a fluorine-based stain-preventing coating agent. The thickness of the protective film 30 may be from 0.1 to 50 μm, for example. The protective film 30 can be formed, for example, by a method including coating the first primary surface S1 with various coating materials for forming a protective film.

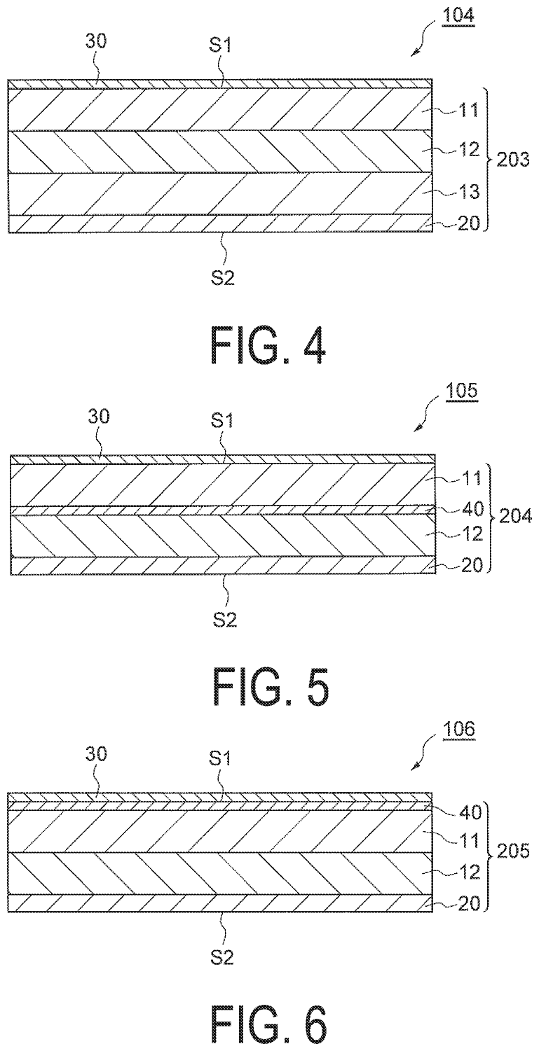

FIG. 4 is a cross-sectional view illustrating another embodiment of the radio wave reflection reducing sheet. A radio wave reflection reducing sheet 104 illustrated in FIG. 4 is provided with a laminate 203 further having a third resin foam layer 13 provided on the second primary surface S2 side of the second resin foam layer 12, and thereby the radio wave reflection reducing sheet 104 differs from the radio wave reflection reducing sheet 103 of FIG. 3. The third resin foam layer 13 is disposed between the second resin foam layer 12 and the pressure sensitive adhesive layer 20. However, the configuration may also be such that the third resin foam layer 13 is the outermost layer of the second primary surface S2 side without the pressure sensitive adhesive layer 20 being provided.

The third resin foam layer 13 may have a thickness from 0.05 to 3.00 mm and a density from 0.21 to 0.95 g/cm³. The density of the third resin foam layer 13 may be greater than the density of the second resin foam layer 12. Increasing the density in the order of the first resin foam layer 11, the second resin foam layer 12, and the third resin foam layer 13 can also contribute to reducing the reflection of radio waves. The thickness of the third resin foam layer 13 may be greater than or equal to 0.10 mm, greater than or equal to 0.20 mm, greater than or equal to 0.30 mm, or greater than or equal to 0.40 mm, and may be less than or equal to 2.00 mm, less than or equal to 1.00 mm, or less than or equal to 0.90 mm. The density of the third resin foam layer 13 may be greater than or equal to 0.30 g/cm³, greater than or equal to 0.40 g/cm³, greater than or equal to 0.50 g/cm³, or greater than or equal to 0.60 g/cm³, and may be less than or equal to 0.90 g/cm³, or less than or equal to 0.80 g/cm³.

The third resin foam layer 13 may have a relative permittivity of from 1.2 to 4.0 at from 76 to 77 GHz. The third resin foam layer 13 may also have a relative permittivity from 1.21 to 4.0. The relative permittivity of the third resin foam layer 13 may be greater than the relative permittivity of the second resin foam layer 12.

The material constituting the third resin foam layer 13 can be selected from the same materials as those constituting the first resin foam layer 11 or the second resin foam layer 12. The laminate 203 having the third resin foam layer 13 can be obtained by the same method used to obtain the laminate 201.

FIG. 5 is a cross-sectional view illustrating another embodiment of the radio wave reflection reducing sheet. A radio wave reflection reducing sheet 105 illustrated in FIG. 5 is configured from a laminate 204 having a light-emitting layer 40 provided between the first resin foam layer 11 and the second resin foam layer 12, and thereby the radio wave reflection reducing sheet 105 differs from the radio wave reflection reducing sheet 103 of FIG. 3.

The light-emitting layer 40 allows the radio wave reflection reducing sheet 105 to be easily detected from outside. The light-emitting layer 40 includes a photoluminescent material. The light-emitting layer 40 can be formed, for example, by printing with an ink containing a photoluminescent material. The thickness of the light-emitting layer 40 can be set within a range at which the function of reflection reduction is sufficiently maintained. For example, the thickness of the light-emitting layer 40 may be from 1 μm to 20 μm.

The position at which the light-emitting layer 40 is provided is not particularly limited as long as the emission of light can be externally detected. For example, as with the laminate 205 of a radio wave reflection reducing sheet 106 illustrated in FIG. 6, the light-emitting layer 40 may be disposed on the first primary surface S1 side of the first resin foam layer 11. In this case, a protective film 30 is typically further provided on the light-emitting layer 40, as illustrated.

The radio wave reflection reducing sheet illustrated above can effectively reduce the reflection of radio waves emitted from a radar in a desired region (for example, the 76 GHz band) of the E-Band frequency band. For example, the strength of radio waves reflected by the radio wave reflection reducing sheet and the adherend is P1 when the radio wave reflection reducing sheet affixed to the adherend, with the second primary surface of the radio wave reflection reducing sheet being oriented to contact with the adherend, is irradiated with radio waves in a direction perpendicular to the first primary surface from the first primary surface side, and the strength of radio waves reflected by a flat metal surface is P0 when the metal surface is irradiated with radio waves in a direction perpendicular to the metal surface. By comparison of P1 and P0, the effect of reducing radio wave reflection by the radio wave reflection reducing sheet can be evaluated. For example, in some or all cases where the requirement that the adherend has a relative permittivity of from 2.5 to 2.9 at 76 GHz and a thickness of from 4 to 10 mm in a direction perpendicular to the first primary surface is satisfied, and when the frequency of radio waves is 77 GHz, P1-P0 may be −10 dB or less. In other words, when comparing P1 with P0, the difference therebetween may be −10 dB or less. In a case where the strength of the reflected waves when the radio wave reflection reducing sheet is affixed to the adherend can be reduced by −10 dB or less compared to the strength of the radio waves reflected by the metal surface, it is possible to further effectively contribute to improved detection accuracy of weak radio waves such as a radio waves reflected from a human body or the like. However, P1-P0 is not necessary to be −10 dB or less for all the adherends satisfying the requirement that it has a relative permittivity of from 2.5 to 2.9 at 76 GHz and has a thickness of from 4 to 10 mm in a direction perpendicular to the first primary surface. From a similar perspective, in some or all cases where the requirement that the adherend has a relative permittivity of from 2.5 to 2.9 at 76 GHz and has a thickness of from 4 to 10 mm in a direction perpendicular to the first primary surface is satisfied, and when the frequency of radio waves is 80 GHz, the difference between P1 and P0 may be −8 dB or less, or −10 dB or less. The upper limit of the difference between P1 and P0 is not particularly limited, and P1-P0 may be, for example, −15 dB or greater when the frequency of radio waves is 76 GHz or 80 GHz. The adherend may be a polycarbonate molded body, for example.

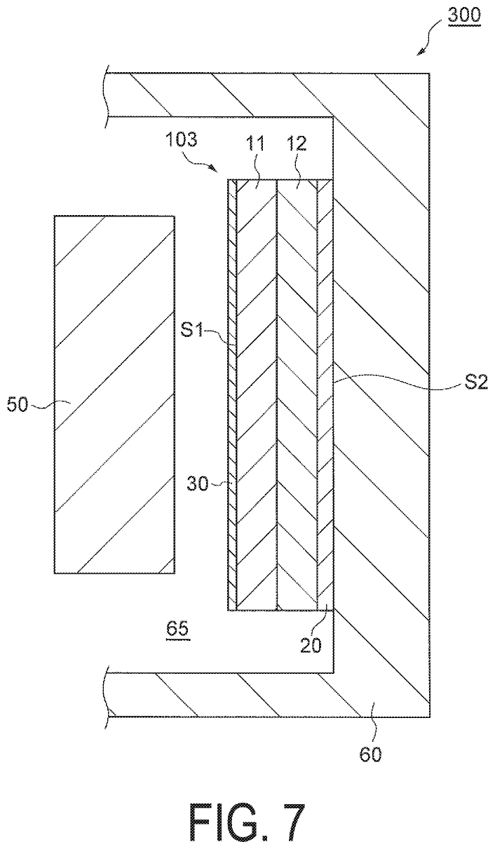

By providing the radio wave reflection reducing sheet in the vicinity of a radar device, detection accuracy of the radar device can be improved. FIG. 7 is a cross-sectional view illustrating an embodiment of a vehicle member having a radio wave reflection reducing sheet, and a radar device. A vehicle member 300 illustrated in FIG. 7 is provided with a body portion 60 that covers a radar device 50, and a radio wave reflection reducing sheet 103 provided on an outer surface of the body portion 60 on the radar device 50 side. The body portion 60 forms an accommodation chamber 65 in which the radar device 50 is installed. The second primary surface S2 is adjacent to the body portion 60, and thereby the radio wave reflection reducing sheet 103 is adhered to the outer surface of the body portion 60, and is oriented such that the first primary surface S1 is positioned at the radar device 50 side. Radio waves emitted from the radar device 50 pass through the radio wave reflection reducing sheet 103 and the body portion 60, and reach an external target object to be detected. By providing the radio wave reflection reducing sheet 103, the proportion of radio waves reflected by the body portion 60 before reaching the target object to be detected can be effectively reduced. A vehicle member having a radio wave reflection reducing sheet can be used to reduce the reflection of radio waves from a radar device that detects a detection target object such as a human body or animal present outside of the vehicle or in the vehicle interior.

The transmittance of 77 GHz radio waves that penetrate the radio wave reflection reducing sheet 103 and the body portion 60 from the radio wave reflection reducing sheet 103 side in a direction perpendicular to the first primary surface S1 of radio wave reflection reducing sheet 103 may be the same as or greater than the transmittance of 77 GHz radio waves that penetrate only the body portion 60 in the same direction as the direction described above. Through this, the radar device 50 can detect a detection target object with weak reflected waves, such as a human body and a two-wheeled vehicle, with even higher accuracy.

### EXAMPLES

The present disclosure will be described in further detail hereinafter using examples. However, the present disclosure is not limited to these examples.

### 1. Resin Foam Sheet Production

### 1-1. Polypropylene Foam Sheet (PP)

Polypropylene with branched chains (Waymax MFX8, available from Japan Polypropylene Corporation), isotactic polypropylene (Vistamaxx 6102 FL, available from Exxon Mobile) and a thermally expanding foaming agent (S2340, available from Kureha Corporation) were melt-kneaded in a same-direction twin screw extruder configured from a plurality of barrels. The thermally expanding foaming agent (S2340) was thermally expandable microspheres formed from: a shell formed from a thermoplastic resin, and a low boiling point liquid hydrocarbon encased in the shell. The extruder temperature was set to reach a maximum of 240° C. The kneaded product was injected into a drop die with a width of approximately 35 cm and a thickness of approximately 2.2 mm using a pump. The thickness of the formed polypropylene foam sheet was approximately 1.14 mm. The polypropylene foam sheet was inserted between two polyethylene terephthalate films and sandwiched between cooling rollers at 25° C. The thickness of the obtained polypropylene foam sheet was measured at five points using a clearance gauge, and the average value was determined. A test piece measuring 5.0 cm×5.0 cm was cut out from the polypropylene foam sheet, and the mass thereof was measured. The density of the polypropylene foam sheet was calculated from the mass and thickness.

### 1-2. Polyethylene (PE) Foam Sheet

Low density polyethylene (Novatec LF128, Japan Polyethylene Corporation) and a master batch (Kureha MB-S3LC, available from Kureha Corporation) containing a thermally expanding foaming agent and polyethylene were melt-kneaded in a single screw extruder. The master batch (MB-S3LC, available from Kureha Corporation) contained 50 mass % of polyethylene and 50 mass % of a thermally expanding foaming agent (52340D, available from Kureha Corporation). The thermally expanding foaming foaming agent (S2340D) was thermally expandable microspheres formed from: a shell formed from a thermoplastic resin, and a low-boiling liquid hydrocarbon encased in the shell. The extruder temperature was set to reach a maximum of 200° C. The polyethylene foam sheet obtained by kneading was inserted between two polyethylene terephthalate films and sandwiched by cooling rollers at 25° C. The thickness of the obtained polyethylene foam sheet was measured at five points using a clearance gauge, and the average value was determined. A test piece measuring 5.0 cm×5.0 cm was cut out from the polyethylene foam sheet, and the mass thereof was measured. The density of the polyethylene foam sheet was calculated from the mass and thickness.

### 1-3. L1-1 to L1-8 and L2-1 to L2-4 (Acrylic Foam Sheets)

The following raw materials were prepared:

### Monomers

ISTA: Isobutyl acrylate (available from Osaka Organic Chemical Industry Ltd.)
IBOA: Isobornyl acrylate (available from Osaka Organic Chemical Industry Ltd.)
2EHA: 2-ethylhexyl acrylate (available from Nippon Shokubai Co., Ltd.)
AA: Acrylic acid (available from Toagosei Co. Ltd.)
HDDA: 1,6-hexanediol diacrylate (Light Acrylate 1.6HX-A, available from Kyoeisha Chemical Co. Ltd.)

### Photopolymerization Initiator

Irgacure 651: 2,2-dimethoxy-1,2-diphenyl-1-one (available from IGM Resins B. V.)

### Dispersant

LUCANT A5515 (ethylene/propylene/maleic anhydride copolymer, available from Mitsui Chemicals, Inc.)

### Thermally Expanding Foaming Agent

FN100SSD (thermally expandable microcapsules configured from a shell of a thermoplastic acrylic resin, and a low boiling point hydrocarbon encased in the shell, available from Matsumoto Yushi-Seiyaku Co., Ltd.)

### Hollow Glass Particles

K-15 (density of 0.15 g/cm³, available from 3M)

### Liner

Cerapeel MIB (E): double-sided silicone-treated polyester liner (thickness of 0.050 mm, available from Toray Industries, Inc.)
Purex A50: single-sided silicone-treated polyester liner (thickness of 0.050 mm, available from Teijin Dupont Films Japan Limited)

### Acrylic Foam Sheet L1-1

Amounts of 0.750 g of LUCANT A5515, 0.225 g of Irgacure 651, 90.0 g of ISTA and 60.0 g IBOA were inserted into a 225 mL glass container and mixed with a rotating orbital mixer at a rotational speed of 2000 rpm for 2 minutes. Oxygen was removed from the obtained monomer mixture by nitrogen bubbling for 15 minutes. The monomer mixture in the glass container was then irradiated with 360 nm ultraviolet radiation for 1 minute, and a viscous monomer mixture containing a polymer component was obtained.

The obtained viscous monomer mixture was fed between two liners (Purex A50 and Cerapeel MIB (E)) from a coating machine head adjusted such that the thickness was 90% of a target value. The liners sandwiching the monomer mixture were passed through a UV chamber configured of two zones provided with UV lamps above and below. The UV strength of the zone on the upstream side was 0.4 mW/cm² both above and below. The UV strength of the downstream side zone was 4.9 mW/cm² on the upper side and 5.3 mW/cm² on the lower side. The movement speed of the liners was 0.3 m/min, and the time for the monomer mixture sandwiched by the liners to pass through the UV chamber was 10 minutes. While the monomer mixture sandwiched by the liners passed through the UV chamber, an acrylic resin sheet was formed by polymerization of the monomers.

The acrylic resin sheet that formed was heated as is in a 150° C. oven for 10 minutes, and thereby the thermally expanding foaming agent was foamed, and an acrylic foam sheet was formed. The thickness of the acrylic foam sheet was measured at five points using a clearance gauge, and the average value was determined. A test piece measuring 5.0 cm×5.0 cm was cut out from the acrylic foam sheet, and the mass thereof was measured. The density of the acrylic foam sheet was calculated from the mass and thickness. At this time, the density of the acrylic resin was assumed to be 1.0 g/cm³.

### Acrylic Foam Sheets L1-2 to L1-8

Acrylic foam sheets L1-2 to L1-8 were produced by the same method as L1-1 with the exception that the amount of the thermally expanding foaming agent and the thickness of the sheets were changed. The density of each acrylic foam sheet was then determined.

### Acrylic Foam Sheet L2-1

An acrylic foam tape PX5005 available from 3M was prepared as the acrylic foam sheet L2-1.

### Acrylic Foam Sheet L2-2

Amounts of 0.150 g of Irgacure 651, 306.9 g of 2EHA, 3.05 g of AA, and 96.75 g of IBOA were inserted into a 900 mL glass container and stirred overnight with a roller-type mixer. Oxygen was removed from the obtained monomer mixture by nitrogen bubbling for 15 minutes. Next, the monomer mixture in the glass container was irradiated with 360 nm ultraviolet radiation for 1 minute, and a viscous monomer mixture containing a polymer component was obtained. Next, 0.785 g of Irgacure 651 and 0.626 g HDDA were added to the glass container. The mixture was stirred once again with a roller-type mixer overnight. An amount of 49.65 g of the obtained viscous monomer mixture and 4.41 g of K-15 were placed in a 150 mL plastic cup and mixed with a rotating orbital mixer for 2 minutes at a rotational speed of 2000 rpm.

Using the obtained monomer mixture, the acrylic foam sheet L2-2 was produced by the same method as that of the acrylic foam sheet L1-1, and the density thereof was determined.

### Acrylic Foam Sheets L2-3 and L2-4

Acrylic foam sheets L2-2 to L1-8 were produced by the same method as L2-2 with the exception that the amount of the thermally expanding foaming agent and the thickness of the sheets were changed. The density of each acrylic foam sheet was then determined.

### 2. Relative Permittivity (c) of the Resin Foam Sheets

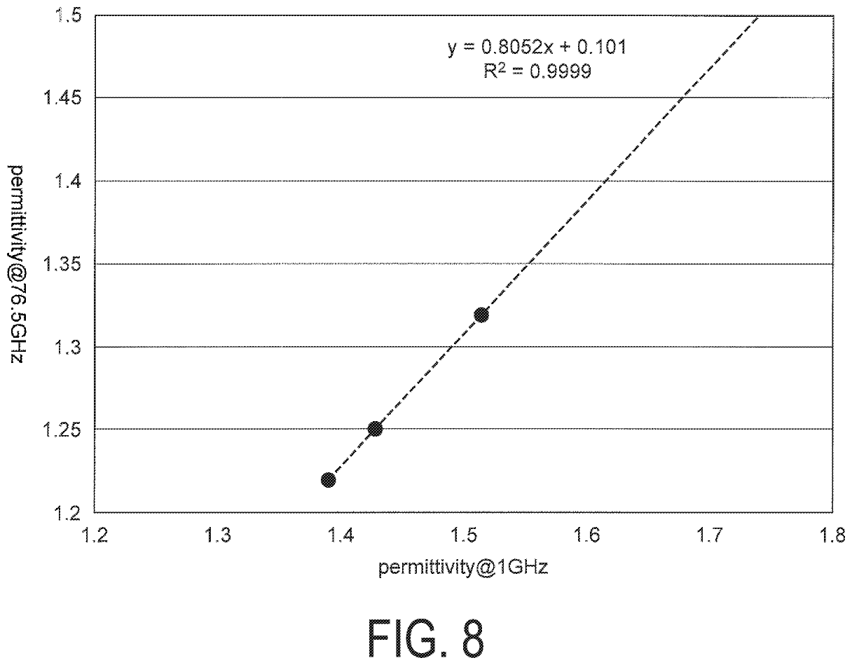

The permittivity of each foam sheet was measured at 76 to 77 GHz through a free space method using a permittivity/dielectric tangent measurement system (DPS10-02, available from Keycom Corp.). Of course, the relative permittivity values of some of the acrylic foam sheets were values obtained by converting a value measured at 1 GHz to a relative permittivity at 76 to 77 GHz. FIG. 8 is a graph showing the correlation between the relative permittivity at 76.5 GHz and the relative permittivity at 1 GHz, and the converted values were determined based on this graph. The relative permittivity in FIG. 8 was measured using an impedance/material analyzer (4291B) and a dielectric material test fixture (16453A) available from Hewlett-Packard Company. Similar products are available from Keysight Technologies, Inc.

### 3. Production of Radio Wave Reflection Reducing Sheet

Resin foam sheets of combinations shown in Table 1 were used as the first resin foam layer (L1) and the second resin foam layer (L2), these resin foam sheets were laminated, and a radio wave reflection reducing sheet having a primary surface of the first resin foam layer as the first primary surface, and a primary surface of the second resin foam layer as the second primary surface was obtained.

### 4. Reflection Level and Transmittance

A metal plate (aluminum plate, thickness of 3 mm) having a flat metal surface was prepared. The strength P0 [dB] of the reflected radio waves when the metal plate was irradiated with 77 GHz or 80 GHz radio waves in a direction perpendicular to the primary surface of the metal plate was measured by the S parameter method. The amount of transmission (radio wave strength) TO [dB] of radio waves of 77 GHz or 80 GHz in air-only space was also measured. A radio wave reflection reducing sheet was affixed to the surface of a polycarbonate molded body (permittivity of 2.7/76 GHz, thickness of 7.2 mm) prepared as an adherend, the radio wave reflection reducing sheet being oriented such that the second primary surface contacted the adherend. Next, the strength P1 [dB] of reflected radio waves when the radio wave reflection reducing sheet was irradiated with radio waves of 77 GHz or 80 GHz in a direction perpendicular to the primary surface of the radio wave reflection reducing sheet, was measured by the S parameter method. The strength T1 [dB] of 77 GHz radio waves transmitted through the radio wave reflection reducing sheet and the adherend was also measured. The reflection level and transmittance were calculated according to the following formulas.
Reflection Level [dB]=P1-P0
Transmittance [dB]=T1-T0
The following condition and measuring devices were applied for measuring the strength of the reflected radio wave by the S parameter method.
Condition: Frequency sweep (75-110 GHz)

### Constitution:

Network analyzer (Agilent Technology, Inc, PNA-X N5242A)
Spectrum analyzer (Keysight Technologies, Inc, N9030A)
Harmonic mixer (Agilent Technology, Inc, 11970W)
Horn antenna (Microwave Factory Co., Ltd., MSGH10-25)
W-band millimeter-wave source module (Hewlett-Packard Company, 83558)
W-band local amplifier (Microwave Factory Co., Ltd., MPA0208-34)
RF power amplifier (Hewlett-Packard Company, 8349B-1 E8257DS12)

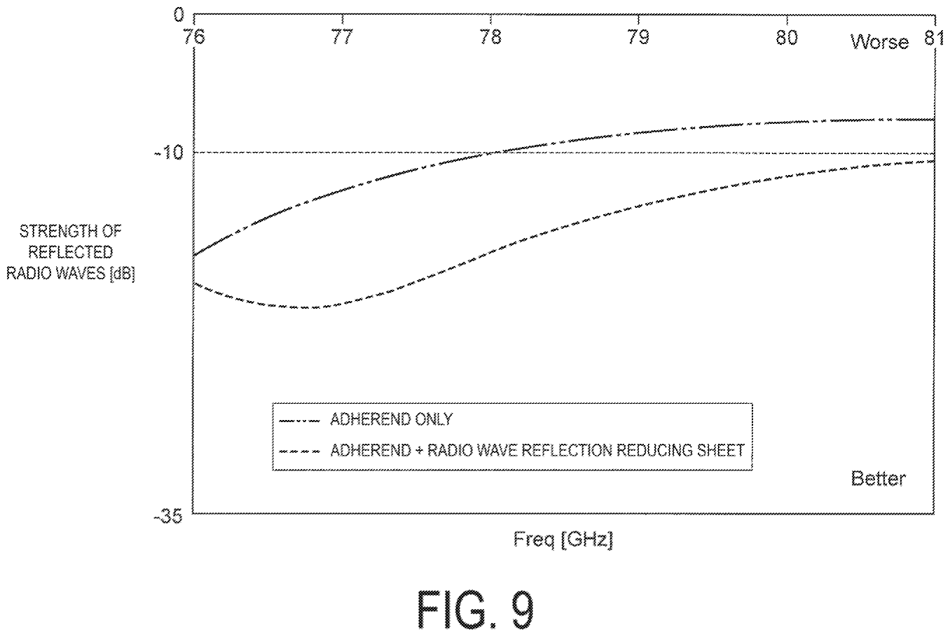

FIG. 9 is a graph showing an example of the relationship between the strength and the frequency of the reflected radio waves when the radio wave reflection reducing sheet was mounted to the polycarbonate molded body as the adherend. Compared to reflected radio waves by the adherend only, the reflection of radio waves at 76 to 81 GHz was effectively reduced by affixing the radio wave reflection reducing sheet to the adherend.

### 5. Results

Table 1 shows the thickness (t), density (d), and relative permittivity (c) of each resin foam layer, and the reflection level and transmittance of the radio wave reflection reducing sheet. Each radio wave reflection reducing sheet, when affixed to the adherend, exhibited a strength of reflected radio waves that was at least −10 dB lower than the strength of the reflected radio waves by the metal plate, and it was confirmed that each radio wave reflection reducing sheet exhibited a sufficient reflection reduction effect for reducing noise in order to detect a human body.[0055]

TABLE 1

| | | | | | | Reflection | Reflection | |
|---|---|---|---|---|---|---|---|---|
| | | | | | | Level | Level | Transmittance |
| | | | t | d | | [dB]/ | [dB]/ | [dB]/ |
| Examples | | | [mm] | [g/cm³] | | 77 GHz | 80 GHz | 77 GHz |
| 1 | L1 | PP | 0.75 | 0.48 | 1.60 | −21.5 | −10.8 | 0.3 |
| | L2 | L2-1 | 0.50 | 0.69 | 1.90*¹ | | | |
| | | (Acrylate) | | | | | | |
| 2 | L1 | L1-1 | 0.64 | 0.41 | 1.37 | −16.0 | −14.0 | 0.5 |
| | | (Acrylate) | | | | | | |
| | L2 | L2-1 | 0.50 | 0.69 | 1.90*¹ | | | |
| | | (Acrylate) | | | | | | |
| 3 | L1 | PE | 0.55 | 0.51 | 1.47 | −19.3 | −12.7 | 0.5 |
| | L2 | L2-1 | 0.50 | 0.69 | 1.90*¹ | | | |
| | | (Acrylate) | | | | | | |
| 4 | L1 | L1-2 | 0.54 | 0.41 | 1.34 | −16.1 | −13.2 | 0.5 |
| | | (Acrylate) | | | | | | |
| | L2 | L2-1 | 0.50 | 0.69 | 1.90*¹ | | | |
| | | (Acrylate) | | | | | | |
| 5 | L1 | L1-1 | 0.64 | 0.41 | 1.37 | −15.9 | −12.6 | 0.4 |
| | | (Acrylate) | | | | | | |
| | L2 | L2-1 | 0.50 | 0.69 | 1.90*¹ | | | |
| | | (Acrylate) | | | | | | |
| 6 | L1 | L1-3 | 0.53 | 0.40 | 1.32 | −17.0 | −12.0 | 0.5 |
| | | (Acrylate) | | | | | | |
| | L2 | L2-2 | 0.49 | 0.73 | 1.82 | | | |
| | | (Acrylate) | | | | | | |
| 7 | L1 | L1-4 | 0.56 | 0.40 | 1.31 | −16.1 | −13.1 | 0.1 |
| | | (Acrylate) | | | | | | |
| | L2 | L2-2 | 0.49 | 0.73 | 1.82 | | | |
| | | (Acrylate) | | | | | | |
| 8 | L1 | L1-5 | 0.59 | 0.40 | 1.30 | −17.0 | −12.6 | 0.1 |
| | | (Acrylate) | | | | | | |
| | L2 | L2-2 | 0.49 | 0.73 | 1.82 | | | |
| | | (Acrylate) | | | | | | |
| 9 | L1 | L1-6 | 0.63 | 0.40 | 1.31 | −17.3 | −12.5 | 0.0 |
| | | (Acrylate) | | | | | | |
| | L2 | L2-2 | 0.49 | 0.73 | 1.82 | | | |
| | | (Acrylate) | | | | | | |
| 10 | L1 | L1-7 | 0.67 | 0.40 | 1.31 | −16.5 | −13.6 | 0.0 |
| | | (Acrylate) | | | | | | |
| | L2 | L2-2 | 0.49 | 0.73 | 1.82 | | | |
| | | (Acrylate) | | | | | | |
| 11 | L1 | L1-8 | 0.58 | 0.40 | 1.31 | −12.2 | −8.1 | 0.0 |
| | | (Acrylate) | | | | | | |
| | L2 | L2-3 | 0.49 | 0.71 | 1.77 | | | |
| | | (Acrylate) | | | | | | |
| 12 | L1 | L1-8 | 0.58 | 0.40 | 1.31 | −16.5 | −13.8 | 0.4 |
| | | (Acrylate) | | | | | | |
| | L2 | L2-3 | 0.49 | 0.71 | 1.77 | | | |
| | | (Acrylate) | | | | | | |
| 13 | L1 | L1-8 | 0.58 | 0.40 | 1.31 | −16.8 | −13.4 | 0.4 |
| | | (Acrylate) | | | | | | |
| | L2 | L2-2 | 0.49 | 0.73 | 1.82 | | | |
| | | (Acrylate) | | | | | | |
| 14 | L1 | L1-8 | 0.58 | 0.40 | 1.31 | −17.2 | −12.7 | 0.4 |
| | | (Acrylate) | | | | | | |
| | L2 | L2-4 | 0.59 | 0.68 | 1.78 | | | |
| | | (Acrylate) | | | | | | |

*¹Value converted from actual measured value (2.18) at 1 GHz

### Radio Wave Reflection Reducing Sheet Having a Light-Emitting Layer

A polypropylene foam sheet (density of 0.48 g/cm³, thickness of 0.60 mm) was produced with the same method used to produce the polypropylene foam sheet PP described above. An ink (TRICK print paint Red, available from So-ken) containing a photoluminescence material was coated onto one primary surface of the obtained resin foam sheet to form a light-emitting layer. The acrylic foam sheet L2-1 described above was laminated onto the light-emitting layer, and a radio wave reflection reducing sheet configured from the first resin foam layer/light-emitting layer/second resin foam layer was obtained. When the obtained radio wave reflection reducing sheet was irradiated with ultraviolet rays from the first resin foam layer side, fluorescence from the light-emitting layer was confirmed.

1. A radio wave reflection reducing sheet comprising a laminate having a first primary surface and a second primary surface; the laminate comprising:
a first resin foam layer having a thickness from 0.05 to 3.00 mm and a density from 0.10 to 0.85 g/cm³; and
a second resin foam layer having a thickness from 0.05 to 3.00 mm and a density from 0.20 to 0.90 g/cm³; the density of the second resin foam layer being greater than the density of the first resin foam layer; and
the first resin foam layer and the second resin foam layer being disposed from the first primary surface side in this order.

2. The radio wave reflection reducing sheet according to claim 1, wherein, the laminate is affixed to an adherend, and in a case where a strength of radio waves reflected by the radio wave reflection reducing sheet and the adherend is P1, with the second primary surface of the radio wave reflection reducing sheet being oriented to contact with the adherend, is irradiated with 77 GHz radio waves in a direction perpendicular to the first primary surface from the first primary surface side, and a strength of radio waves reflected by a flat metal surface is P0 when the metal surface is irradiated with 77 GHz radio waves in a direction perpendicular to the metal surface, in some or all cases where the requirement that the adherend has a relative permittivity of from 2.5 to 2.9 at 76 GHz and has a thickness of from 4 to 10 mm in a direction perpendicular to the first primary surface is satisfied, P1-P0 is −10 dB or less.

3. The radio wave reflection reducing sheet according to claim 1, wherein, when the laminate in affixed to an adherend, in a case where a strength of radio waves reflected by the radio wave reflection reducing sheet and the adherend is P1, with the second primary surface of the radio wave reflection reducing sheet being oriented to contact with the adherend, is irradiated with 80 GHz radio waves in a direction perpendicular to the first primary surface from the first primary surface side, and a strength of radio waves reflected by a flat metal surface is P0 when the metal surface is irradiated with 80 GHz radio waves in a direction perpendicular to the metal surface, in some or all cases where the requirement that the adherend has a relative permittivity of from 2.5 to 2.9 at 76 GHz and has a thickness of from 4 to 10 mm in a direction perpendicular to the first primary surface is satisfied, P1-P0 is −8 dB or less.

4. The radio wave reflection reducing sheet according to claim 1, wherein the first resin foam layer has a relative permittivity from 1.1 to 4.0 at from 76 to 77 GHz; the second resin foam layer has a relative permittivity from 1.2 to 4.0 at from 76 to 77 GHz; and the relative permittivity of the second resin foam layer is greater than the relative permittivity of the first resin foam layer.

5. The radio wave reflection reducing sheet according to claim 1, wherein the laminate further comprises a third resin foam layer disposed on the second primary surface side of the second resin foam layer; the third resin foam layer has a thickness from 0.05 to 3.00 mm and a density from 0.21 to 0.95 g/cm³; and the density of the third resin foam layer is greater than the density of the second resin foam layer.

6. The radio wave reflection reducing sheet according to claim 5, wherein the third resin foam layer has a relative permittivity from 1.2 to 4.0 at from 76 to 77 GHz; and the relative permittivity of the third resin foam layer is greater than the relative permittivity of the second resin foam layer.

7. The radio wave reflection reducing sheet according to claim 1, wherein the laminate further comprises a light-emitting layer containing a photoluminescent material; and the light-emitting layer is disposed between the first resin foam layer and the second resin foam layer, or on the first primary surface side of the first resin foam layer.

8. The radio wave reflection reducing sheet according to claim 1, wherein the laminate further comprises a pressure-sensitive adhesive layer provided as an outermost layer on the second primary surface side.

9. A vehicle member comprising:
a body portion; and
the radio wave reflection reducing sheet described in claim 1, provided on an outer surface of the body portion; wherein the second primary surface of the laminate is adjacent to the body portion.

10. The vehicle member according to claim 9, wherein a transmittance of 77 GHz radio waves passing through the radio wave reflection reducing sheet and the body portion from the radio wave reflection reducing sheet side in a direction perpendicular to the first primary surface of the radio wave reflection reducing sheet is the same as or greater than the transmittance of 77 GHz radio waves passing through only the body portion in the same direction as the direction described above.

11. The radio wave reflection reducing sheet according to claim 1, further comprising a protective film provided on the first primary surface.
